(19) United States
(12) Patent Application Publication
(10) Pub. No.: US 2018/0019985 A1
(43) Pub. Date: Jan. 18, 2018

(54) DISTRIBUTED KEY/VALUE STORE SYSTEM USING ASYNCHRONOUS MESSAGING SYSTEMS

(71) Applicant: FUGUE, INC., Frederick, MD (US)

(72) Inventor: Alexander E. SCHOOF, Herndon, VA (US)

(73) Assignee: FUGUE, INC., Frederick, MD (US)

(21) Appl. No.: 15/653,219

(22) Filed: Jul. 18, 2017

Related U.S. Application Data
(60) Provisional application No. 62/363,803, filed on Jul. 18, 2016.

(51) Int. Cl. H04L 29/06; G06F 17/30; H04L 9/32; H04L 29/08

(52) U.S. Cl. CPC H04L 63/062; H04L 63/123; H04L 9/3242; G06F 17/30377; H04L 63/061; H04L 67/1095; H04L 67/2842

(57) ABSTRACT

A distributed key/value store system using asynchronous messaging systems is provided. A plurality of instances in a cloud computing environment each execute software that enables reading from and writing to a respective local cache, and that enables sending messages through a messaging queue to a cloud environment operating system. When a configuration value is updated locally at an instance, the instance sends a message to the cloud environment operating system, instructing it to update a database and broadcast the update to other instances through each instance's messaging queue. In some embodiments, each instance may read and write to the database directly, and may publish updates to the queues of other instances directly. In some embodiments, a managed encryption key service is used to encrypt sensitive information, securely distribute it via distributed key/value store systems, and authenticate and decrypt it by instances of the distributed key/value store systems.

### CROSS-REFERENCE TO RELATED APPLICATION

This application claims the benefit of U.S. Provisional Patent Application No. 62/363,803, filed on Jul. 18, 2016, the contents of which are incorporated herein by reference in their entirety.

### FIELD

This disclosure relates generally to cloud-based computing environments, and to cloud-based computing environments in which a user is able to specify a desired infrastructure using a programming language configured to interface with a cloud environment operating system (OS).

### BACKGROUND

Cloud computing allows individuals, businesses, and other organizations to implement and run large and complex computing environments without having to invest in the physical hardware (such as a server or local computer) necessary to maintain such environments. Rather than having to keep and maintain physical machines that perform the tasks associated with the desired computing environment, an end-user can instead “outsource” the computing to a computing “cloud” that can implement the desired computing environment in a remote location. The cloud can consist of a network of remote servers hosted on the Internet that are shared by numerous end-users to implement each of their desired computing needs. Simplifying the process to build, optimize, and maintain computing environments on the cloud can improve the end-user experience. Allowing a user to develop a robust computing infrastructure on the cloud, while seamlessly optimizing and maintaining it, can minimize frustrations associated with corrupted infrastructure that can occur during the course of operating a computing environment on the cloud.

### SUMMARY

As cloud-based systems grow to support hundreds of thousands or millions of users, such systems may encounter various complex problems. For example, cloud-based systems may face application-level issues, such as ensuring the security of a login system, dealing with internalization and time zones, and ensuring that users can easily locate desired functionalities and services. Cloud-based systems may additionally face infrastructure-based issues, such as deciding what instance to use for web servers, deciding where to host static assets, and deciding on which metrics to use to horizontally scale each tier. Existing methods for addressing these issues include disjointed approaches in which different people handle and address the application and infrastructure issues with disjointed solutions.

As cloud-based systems get larger and more complex, a third set of problems emerges. These problems touch on both application and infrastructure, and are not effectively or efficiently addressed by disjointed solutions. For example, application-infrastructure problems may include how to share or publish an infrastructure configuration so that an application can use it, how to pick a single instance of an application to perform a task, or how to make sure that all of the instances of an application perform the same task and/or agree on the state of the system. In one sense, these problems can be viewed as coordination problems.

Existing solutions for coordination in large cloud-based systems are inefficient and ineffective. For example, service registries typically require nodes or instances in distributed systems to all communicate directly with one another, and to do so via synchronous communication methods. These arrangements scale very poorly when cloud-based systems require larger numbers of nodes (e.g., 7 nodes or more), greatly increasing computational requirements for users running such systems. Furthermore, coordinating distributed systems via synchronous communication systems may create security vulnerabilities, such as by requiring nodes to maintain open ports for incoming messages. Additionally, coordinating distributed systems via synchronous communication systems may foreclose the possibility of maintaining nodes in different network fabrics that have different network security systems and/or different access control rules.

Accordingly, there is a need for improved systems and methods for managing configuration and coordination in cloud-based systems.

In some embodiments, a method for updating a value in a distributed key/value store system comprises, at a network communication component, receiving, from an instance of the distributed key value store system, a message indicating a key and corresponding value; and, in response to receiving the message: storing the key and corresponding value in a database; and publishing an update indicating the key and corresponding value to a plurality of instances of the key/value store system.

In some embodiments, a non-transitory computer-readable storage medium stores instructions for updating a value in a distributed key/value store system, the instructions comprising instructions for: at a network communication component: receiving, from an instance of the distributed key value store system, a message indicating a key and corresponding value; and in response to receiving the message: storing the key and corresponding value in a database; and publishing an update indicating the key and corresponding value to a plurality of instances of the key/value store system.

In some embodiments, a system for updating a value in a distributed key/value store system comprises one or more instances of the distributed key/value store system and memory storing instructions that, when executed, cause the system to: at a network communication component: receive, from an instance of the distributed key value store system, a message indicating a key and corresponding value; and in response to receiving the message: store the key and corresponding value in a database; and publish an update indicating the key and corresponding value to a plurality of instances of the key/value store system.

In some embodiments, a method for retrieving a value in a distributed key/value store system comprises: at an instance of the distributed key/value store system: receiving a request to retrieve a value; and in response to receiving the request to retrieve the value: determining whether the value is stored in a local cache associated with the instance of the distributed key/value store system; in accordance with the determination that the value is stored in the local cache, retrieving the value from the local cache; and in accordance with the determination that the value is not stored in the local cache: sending a message to a network communication component of the distributed key/value store system, the message indicating a key corresponding to the requested value; and receiving, from the network communication component, a response including the requested value.

In some embodiments, a non-transitory computer-readable storage medium stores instructions for retrieving a value in a distributed key/value store system, the instructions comprising instructions for: at an instance of the distributed key/value store system: receiving a request to retrieve a value; and in response to receiving the request to retrieve the value: determining whether the value is stored in a local cache associated with the instance of the distributed key/value store system; in accordance with the determination that the value is stored in the local cache, retrieving the value from the local cache; and in accordance with the determination that the value is not stored in the local cache: sending a message to a network communication component of the distributed key/value store system, the message indicating a key corresponding to the requested value; and receiving, from the network communication component, a response including the requested value.

In some embodiments, a system for retrieving a value in a distributed key/value store system comprises one or more instances of the distributed key/value store system and memory storing instructions that, when executed, cause the system to: at an instance of the distributed key/value store system: receive a request to retrieve a value; and in response to receiving the request to retrieve the value: determine whether the value is stored in a local cache associated with the instance of the distributed key/value store system; in accordance with the determination that the value is stored in the local cache, retrieve the value from the local cache; and in accordance with the determination that the value is not stored in the local cache: send a message to a network communication component of the distributed key/value store system, the message indicating a key corresponding to the requested value; and receive, from the network communication component, a response including the requested value.

In some embodiments, a method for securely publishing values via a distributed key/value store system comprises: encrypting a data key and an authentication key; at a first instance of the distributed key/value store system: using the data key to encrypt a value; using the authentication key to compute a first hash of the encrypted value; and publishing the encrypted value, the first hash, and the encrypted keys, via an asynchronous messaging service, to a plurality of instances of the distributed key/value store system.

In some embodiments, a non-transitory computer-readable storage medium storing instructions for securely publishing values via a distributed key/value store system comprises instructions for: encrypting a data key and an authentication key; at a first instance of the distributed key/value store system: using the data key to encrypt a value; using the authentication key to compute a first hash of the encrypted value; and publishing the encrypted value, the first hash, and the encrypted keys, via an asynchronous messaging service, to a plurality of instances of the distributed key/value store system.

In some embodiments, a system for securely publishing values via a distributed key/value store system comprises one or more instances of the distributed key/value store system and memory storing instructions that, when executed, cause the system to: encrypt a data key and an authentication key; at a first instance of the distributed key/value store system: use the data key to encrypt a value; use the authentication key to compute a first hash of the encrypted value; and publish the encrypted value, the first hash, and the encrypted keys, via an asynchronous messaging service, to a plurality of instances of the distributed key/value store system.

### BRIEF DESCRIPTION OF THE DRAWINGS

FIG. 1 illustrates an exemplary cloud computing environment in accordance with some embodiments.

FIG. 2 illustrates an exemplary cloud operating system process in accordance with some embodiments.

FIG. 3 illustrates an exemplary cloud operating system functional block diagram.

FIG. 4 illustrates a distributed key/value store system using asynchronous messaging systems, in accordance with some embodiments.

FIG. 5 is a is a flowchart showing method 500, which is an exemplary process for publishing a new value using a system including a distributed key/value store, in accordance with some embodiments.

FIG. 6 is a flowchart showing method 600, which is an exemplary method for fetching a requested value at an instance of a system including a distributed key/value store, in accordance with some embodiments.

FIG. 7 is a flowchart showing method 700, which is an exemplary method for securely publishing sensitive data using a system including a distributed key/value store and for reading the securely published data, in accordance with some embodiments.

### DETAILED DESCRIPTION

A cloud computing system (“cloud”) is a large distributed computer system that is shared by multiple clients and is used to virtualize computing environments thereby liberating end-users from the burdens of having to build and maintain physical information technology infrastructure at a local site. These systems also allow users to quickly scale up and down based on their current computing needs.

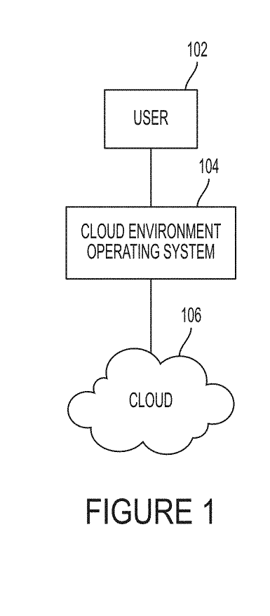

FIG. 1 illustrates an exemplary cloud computing environment according to examples of the disclosure. The cloud computing environment depicted in FIG. 1 comprises user 102, who may wish to implement a computing environment on a cloud 106. Examples of users 100 can include individuals, businesses, or other organizations that wish to utilize the distributed computing system provided by the cloud to implement a computing environment such as a web server, a computer network, a computer database operation, etc.

The cloud 106, as previously discussed, is one or more distributed generalized computers that provide the computing resources to a user to allow them to implement their desired computing environment. Commercial cloud computing services such as AMAZON WEB SERVICES, MICROSOFT AZURE, GOOGLE CLOUD PLATFORM, are examples of distributed computer networks (clouds) available to users (for a fee) and allow them to build and host applications and websites, store and analyze data, among other uses. Clouds are scalable, meaning that the computing resources of the cloud can be increased or decreased based on the real-time needs of a particular user. In one example, a cloud 104 can be utilized to implement a website run by a user 102. The cloud 106 can maintain and operate a web-server based on the specifications defined by the user 102. As web-traffic to the website increases, the cloud can increase the computing resources dedicated to the website to match the surge in traffic. When web traffic is sparse, the cloud 106 can decrease the computing resources dedicated to the website to match the decrease in traffic.

A cloud environment operating system (OS) 104 can help to facilitate the interaction between a user 102 and a cloud computing environment 106. A conventional operating system manages the resources and services of a single computer. In contrast, an cloud environment operating system may manage the resources and services of a cloud environment.

A cloud environment operating system can automate the creation and operation of one or more cloud infrastructures and can create and destroy computing instances on one or more cloud service providers. While the example of FIG. 1 illustrates the infrastructure OS as a stand-alone entity, the example should not be considered limiting. The infrastructure OS can be run on a client device, on a server such as a third party server, or located on a cloud service provider system that runs and executes the computing environment. The infrastructure OS operates separately and interfaces with the cloud computing environment including any command line interfaces or operating systems used by the cloud to build and maintain the computing infrastructure.

An infrastructure OS 104 can interface with a user 102 by allowing the user to specify a desired computing infrastructure in a simplified and concise manner. In one example, a user 102 can specify a computing environment using a programming language designed to interface with the infrastructure OS 104.

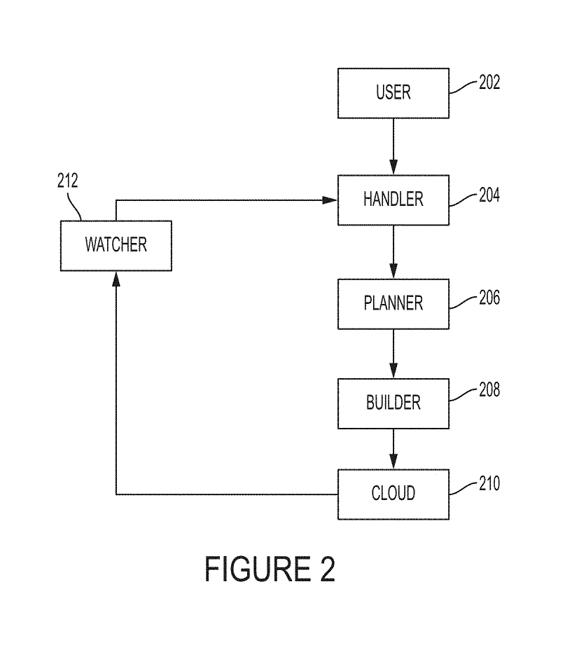

FIG. 2 illustrates an exemplary cloud operating system process according to examples of the disclosure. At step 202, a user can create a composition that describes the computing infrastructure that they want to build in the cloud. In some embodiments, the composition can be written in the form of a declaration which is written in a domain specific programming language. Once the user writes the composition, it can be translated into a hardware-friendly language that is compatible with the cloud operating system that will process the composition to generate the desired infrastructure.

At step 204 the composition generated by the user can be sent to a handler. The handler can capture and version the composition and determine if the composition drafted by the user is a new build (e.g., generating a new computer infrastructure from scratch) or an update to a previously existing infrastructure already running on the cloud. Once the handler receives the composition and makes the determinations described above, it can then trigger the build process by sending the composition to a planning stage.

At step 206, the composition can be passed from the handler stage to planner stage wherein the composition generated by the user is run through a series of modules (described in further detail below) that convert it into a series of instructions to be sent to a builder that will ultimately build the infrastructure in the cloud. The planner stage in addition to interpreting the language of the composition can also perform operations on the composition to determine whether or not there are any errors or structural faults with the composition as written by the user.

At step 208, the planner 206 can transmit the instructions created from the composition to a builder. The builder can take the instructions and build, update, or destroy the infrastructure specified by the user in the specified cloud.

At step 210, the cloud can run the infrastructure specified by the builder in step 208. As the cloud is running the specified infrastructure, should any errors occur in the operation of the infrastructure, the cloud can notify a watcher algorithm at step 212 which can then trigger a rebuild at the handler step 204 of the components of the infrastructure that have generated the error.

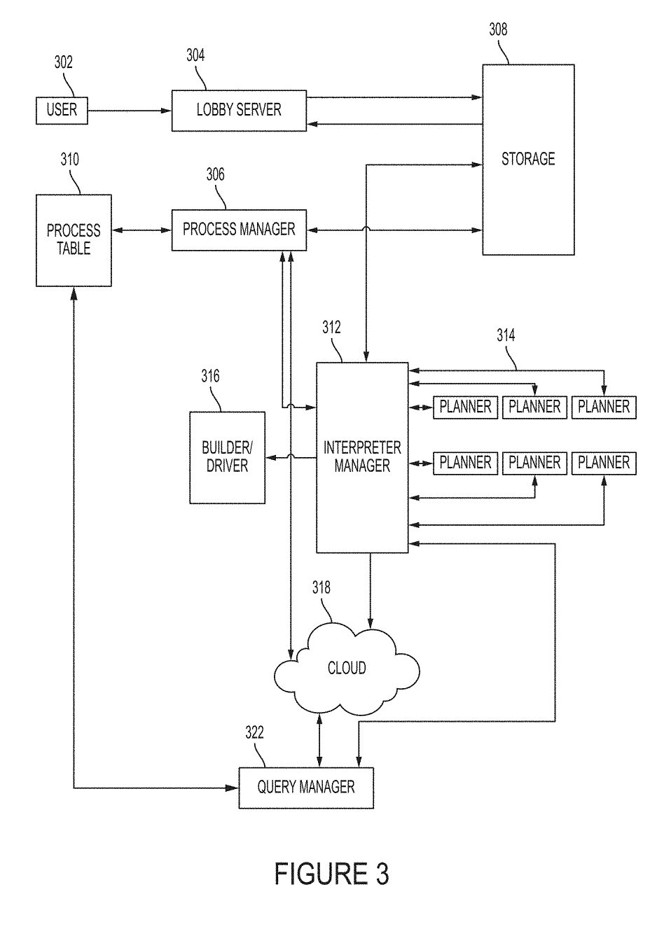

FIG. 3 illustrates an exemplary cloud operating system functional block diagram according to examples of the disclosure. The functional block diagram illustrated in FIG. 3 can, in some examples, implement the process described in FIG. 2.

Block 302 can represent the user process that occurs before operation of the infrastructure OS as described above with respect to FIGS. 1-2. As previously discussed, the user can declare an infrastructure using user-friendly syntax which can then be converted to a lower level language that can be interpreted by the infrastructure OS to build a desired infrastructure on the cloud. User 302 can represent one user, or in some examples can represent multiple users, each of which has specified a desired computing infrastructure to be implemented on a cloud, or multiple clouds.

Block 304 can represent a lobby server. Lobby server 304 can receive low level code (otherwise known as a command line interface) from one or more users and performs a “pitch and catch process” that receives code from one or more users and unpacks it (e.g., distill the parts of the code that will interface with the infrastructure OS) and stores any data that is needed to compile the code and routes the information that comes from the user to the appropriate modules within the infrastructure OS. In addition, the lobby server 304 can identify all of the processes associated with a particular user's command line interface and apply process “tags” to those processes. The process tags can allow the infrastructure OS to track where in the system the processes are currently being executed. This feature can allow for simplicity in scheduling management as will be discussed further below. Lobby server 304 may be communicatively coupled with storage 308.

The lobby server 304 can also handle external data requests. If a request is made to the infrastructure OS for certain forms of data about the run-time environment of the infrastructure OS, the lobby server 304 is able to receive the request, execute it, and send the acquired data to the appropriate stake holder.

Once the code received from the user has been processed by the lobby server 304, the processed code can then be sent to process manager 306. The process manager 306 can manage a process table 310 which lists each and every process to be run by the infrastructure OS. In other words, one set of instructions to build a particular infrastructure by a particular user can be handled as a process. Another set of instructions to build infrastructure by another user can be handled as a separated process. The process manager 306 can manage each separate users tasks as processes within the system by assigning it a process ID and tracking the process ID through the system. Each user's individual tasks to be executed by the infrastructure OS can be managed as separate entities. In this way, the process manager 306 can enable the infrastructure OS to operate as a “multi-tenant” system as opposed to a single-user system. The infrastructure OS can handle requests for infrastructure from multiple users simultaneously rather than being dedicated to a single user or single machine.

In addition to the functions described above, the process manager 306 can also perform status checks on the implementation of the infrastructure in the cloud. In pre-determined time intervals, the process manager 306 can initiate a process whereby a signal is sent to the query manager 322 to determine the status of the infrastructure in the cloud. The query manager 322 can determine the status of the user's infrastructure and send commands to the interpreter manager 312 to take action (described further below) if it is determined from the query manager that the user's infrastructure specification does not match infrastructure present on the cloud.

Once the process manger identifies the process to be executed on the infrastructure OS and stores the processes on process table 310, it can then send those processes to the Interpreter Manager 312 to be converted into a set of instructions that can ultimately be executed by the cloud.

The interpreter manager 312 can be responsible for converting the user's command line interface language (e.g., high level declaration) into a series of specific instructions that can be executed by the infrastructure OS. The interpreter manager 312 can achieve this by employing a series of planning modules 314 that accept, in some examples, resource tables at its input and generates resource tables in which any omissions in the syntax provided by the user are filled in. The interpreter manager 312 can review a resource table sent by the user and send it to the series of planning modules 314 based on what infrastructure needs have been declared by the user. The planning modules 314 alter the user's resource table and return it to the interpreter manager 312. This process may be repeated with other planning modules until the final correct version of the resource table is complete. The interpreter manager 312 then converts the resource table into a machine instruction file which can be referred to as a low level declaration of the computer infrastructure to be built on the cloud. The low level declaration is then sent to the builder/driver 316 (discussed in detail below).

### Exemplary Architecture for a Distributed Key/Value Store System

As explained above, there is a need in modern cloud-computing environments (such as cloud 106) for improved systems and methods for managing configuration and coordination. The systems and techniques disclosed herein may, in some embodiments, be useful in providing said systems and methods for managing configuration and coordination in cloud computing environments. In some embodiments, a system for managing configuration and coordination in a cloud computing environment may comprise a distributed key/value store having features and semantics making it useful for coordination, configuration sharing, and credential synchronization via asynchronous messaging systems.

In some embodiments, the systems and methods disclosed herein may be used to efficiently replicate, store, and distribute values across a distributed (e.g., cloud-based) storage system, where a plurality of instances or nodes may read from and send instructions to write to a central database of values. Whenever a new value is written to the database, the system may automatically distribute the new value to each of the plurality of instances in the system, and the new value may be written to a local cache at each of the plurality of instances. Communication between the nodes and the central database may be facilitated by asynchronous messaging protocols, and distribution of newly stored or updated values may be facilitated by asynchronous messaging and associated notification services by which the plurality of instances may be subscribed to a common topic to listen for updates.

In the context of cloud environment operating systems, the systems and methods disclosed herein may facilitate the fast, efficient, and secure sharing of vital information such as configuration variables across a large number of distributed instances that are part of the cloud environment operating system. As just one example, a distributed key/value store system as disclosed herein may be used to store signing keys (as values) in a secure database, and to distribute, via secure asynchronous messaging, encrypted signing keys when the key is called by an instance in a cloud environment operating system that requires the signing key to encrypt or decrypt a message that is to be sent to another component of the operating system. The signing keys stored in the database as values may be identified by an identifier key (using the word in the sense of the term “key/value,” where a key is an identifier for a stored value), and the signing keys may be replaced or updated periodically, and distributed efficiently and securely to the distributed instances that need access to the signing keys. The systems and methods disclosed herein may be more computationally efficient than systems that require all distributed nodes to communicate directly with one another, and may be more secure than systems that utilize synchronous messaging.

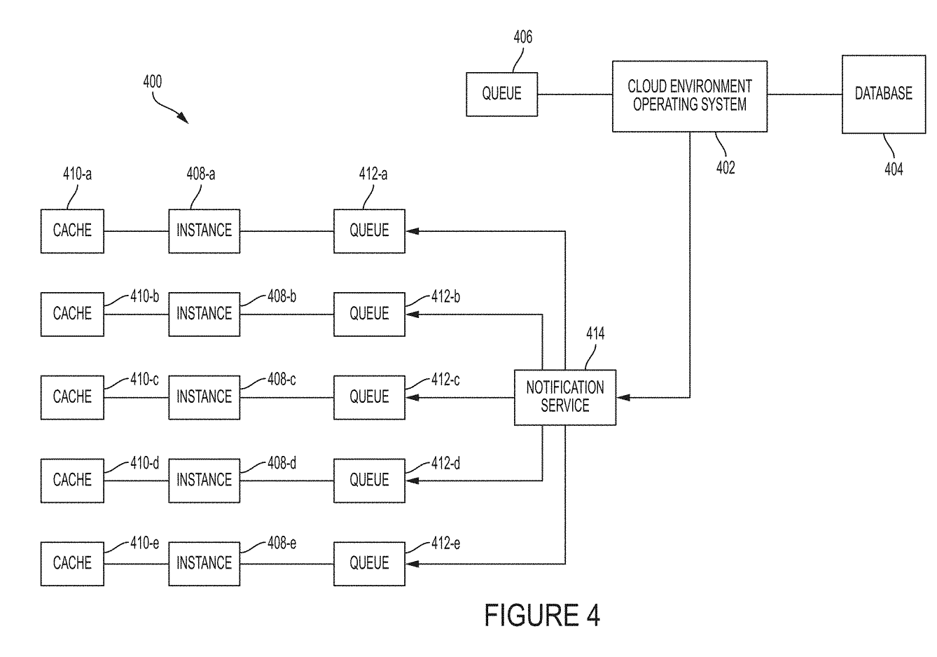

FIG. 4 illustrates a distributed key/value store system using asynchronous messaging systems, in accordance with some embodiments. In some embodiments, system 400 may be part of a cloud computing system.

As will be explained further below, the system comprises a cloud environment operating system including software configured to send and receive messages to and from various distributed instances or nodes of the system; the system further comprises software (e.g., code) that may be installed and run on every instance or node that needs to publish or consume data from the system. In some embodiments, the code installed and run on each instance may be referred to as a binary. The binary may present a local representational state transfer (RESTful) interface by which software on a node can perform operations against a data store, such as publishing a new value, reading a value, listing values, and deleting values. The system may leverage asynchronous communication systems to send information between the database and distributed instances using message queues and notification services. Whenever a node publishes a key/value pair, the system may replicate it to every other node/instance. For example, a developer who is running the binary on a laptop, as well as on a plurality of web servers, may publish a key/value pair in the system, and the pair may be automatically replicated to each of the web servers, where the servers' software can use it.

In some embodiments, system 400 comprises cloud environment operating system 402. In some embodiments, cloud environment operating system 402 may have some or all of the properties of cloud environment operating system 104, as discussed above. In some embodiments, cloud environment operating system 402 may have some or all of the properties of the various components of the system shown in FIG. 3 and discussed above (where elements 304, 306, 308, 310, 312, 314, 316, and 322 may collectively be termed a cloud environment operating system).

In some embodiments, system 400 further comprises database 404, which is communicatively coupled to cloud environment operating system 402. In some embodiments, database 404 may be any database suitable for storing configuration data, log information, or other information useful or necessary to the operation or coordination of a cloud-based system. In some embodiments, database 404 may be any database capable of prefix searching, of retrieving values based on specific keys, and of performing atomic put operations. In some embodiments, database 404 may be a non-relational database, such as AMAZON'S DYNAMODB.

In some embodiments, system 400 further comprises messaging queue 406. In some embodiments, messaging queue 406 is associated with cloud environment operating system 402, and may be a messaging queue through which cloud environment operating system 402 may receive messages via a distributed queue messaging service. In some embodiments, queue 406 may support the receipt of programmatic messages through web service applications as a means of communicating over the Internet. In some embodiments, queue 406 may be an AMAZON SIMPLE QUEUE SERVICE (SQS) queue, or may be a messaging queue compatible with any cloud service, AMAZON WEB SERVICES, MICROSOFT AZURE, and GOOGLE CLOUD PLATFORM.

In some embodiments, system 400 further comprises a plurality of instances 408-a through 408-e. In other embodiments, any number of instances may be present. In some embodiments, the number of instances may change over time as new instances are added or old instances are removed. In some embodiments, each instance 408 may be referred to as a node. On each of the instances 408-a through 408-e, the binary discussed above that presents a local RESTful interface by which software on each node can perform operations against a data store may be installed. In some embodiments, the binary may be a statically linked binary that does not require any language runtimes or libraries to be installed. In some embodiments, the version of the binary that is compatible with a local system may be downloaded from the Internet and installed on the local machine. In some embodiments, an installation package may configure the binary to run at boot. In some embodiments, a cloud operating system (such as the systems described above with reference to FIGS. 2 and 3) may automatically provision within the relevant cloud service roles and their required permissions for instances that will be running the binary associated with the system.

In some embodiments, the binary may be included in any instance that is created virtually in the cloud. In some embodiments, a cloud operating system may automatically include the binary in all images (e.g., AMAZON MACHINE IMAGES (AMIs)) and containers included in a library of images associated with the cloud operating system. In some embodiments, the binary may align seamlessly with a cloud environment operating system of a cloud operating system, and may be simpler and lighter than other solutions that require running clusters, that require maintenance, and/or that lack mountable key space.

In some embodiments, system 400 further comprises caches 410-a through 410-e, which may correspond respectively to instances 408-a through 408-e. In some embodiments, caches 410-a through 410-e are local caches to their respective instances that are used to store key/value pairs that have been received by the respective instance. Each cache 410-a through 410-e may be any data storage medium suitable to store key/value pairs or any other data regarding coordinating a cloud-based application or service.

In some embodiments, system 400 further comprises queues 412-a through 412-e, which may correspond respectively to instances 408-a through 408-e. In some embodiments, queues 412-a through 412-e may share some or all of the properties of queue 406, including that they may be may be messaging queues through which the associated instance may receive messages via a distributed queue messaging service, may support the receipt of programmatic messages through web service applications as a means of communicating over the Internet, and may be an AMAZON SIMPLE QUEUE SERVICE (SQS) queue when running on AWS, or a messaging queue compatible with any cloud service. In some embodiments, a queue may be created by cloud environment operating system 402 for each instance associated with system 400, or each instance running the binary associated with system 400. Each instance may then listen on its respective queue for updates to the key/value store. One benefit of this arrangement is that system 400 does not require that instances have open ports to receive updates, which improves security and makes network configuration simple and efficient.

In some embodiments, system 400 further includes notification service 414. Each queue 412-a through 412-e may be subscribed to notification service 414, such that notification service 414 may distribute messages received from cloud environment operating system 402 to each instance 408 through the instance's respective queue 412. In some embodiments, notification service 414 and queues 412-a through 412-e may enable system 400 to implement “fan out” behavior, such that information may be published to a single queue end-point, and various instances may retrieve messages from that endpoint through respective associated queues. In some embodiments, notification service 414 may be AMAZON NOTIFICATION SERVICE (ANS) associated with AWS, or may be any other notification service compatible with cloud services and suitable to distribute messages from cloud environment operating system 402 to queues 412-a through 412-e.

### Write Operations in a Distributed Key/Value Store System

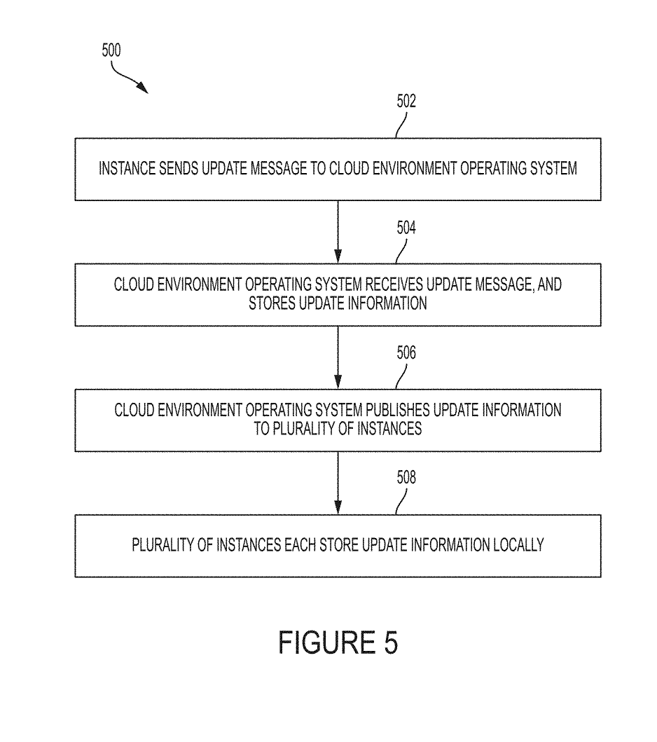

FIG. 5 is a flowchart showing method 500, which is an exemplary process for publishing a new value using a system including a distributed key/value store, in accordance with some embodiments. In some embodiments, method 500 may be performed by system 400.

At step 502, an instance sends an update message to a cloud environment operating system. For example, instance 408-a may send an update message to cloud environment operating system 402. In some embodiments, the update message may be sent via a messaging queue associated with the cloud environment operating system, such as messaging queue 406 for messages sent to cloud environment operating system 402. In some embodiments, the message sent may include update information such as a key/value pair (e.g., a new key/value pair declared by a user of the instance sending the message), as well as metadata, such as a version number and other information corresponding to the location, time, and nature of the update message.

In some embodiments, sending messages via a messaging queue may comprise long-pulling, whereby the receiving system intermittently polls a message queue to check whether there are any inbound messages awaiting the system on the queue. In some embodiments, a system may poll its queue once every 20 seconds, timing out after 20 seconds in the event that no messages are on the queue, and re-polling again thereafter. In some embodiments, a system may poll its queue more frequently (e.g., without waiting 20 seconds) if one or more messages is received during a previous poll.

In some embodiments, using asynchronous messaging systems (e.g., messaging queues, long-polling) may be advantageous because it may increase flexibility and security for systems distributed across various different networks. For example, one distributed system may have nodes/instances located in different network fabrics where the network fabrics have different network security systems and different access control rules. However, asynchronous messaging systems may merely require that each node has outbound Internet access to poll its messaging queue, and this permission alone may be sufficient to send and receive the messages and information necessary to leverage the system explained herein. Because outbound Internet access for polling an asynchronous messaging system may be sufficient to send and receive messages in accordance with certain systems and methods explained herein, instances of said systems may in some embodiments have no open network ports, thereby increasing network security.

At step 504, the cloud environment operating system receives update message and stores update information. In some embodiments, the cloud environment operating system may receive the message and may responsively durably store the update information and/or metadata contained in the message. For example, when it receives the update message from instance 408-a, cloud environment operating system 402 may durably write the update information and/or metadata contained in the message to a log in database 404.

At step 506, the cloud environment operating system publishes update information to a plurality of instances. In some embodiments, once the update information indicated by the original update message has been stored by the cloud environment operating system, the cloud environment operating system may then automatically publish the updated data (e.g., information corresponding to the update) to each of the plurality of instances associated with the system. In some embodiments, the publishing of update information from the cloud environment operating system to the plurality of instances is carried out by sending a message via each instance's respective messaging queue. For example, in the system of FIG. 4, once cloud environment operating system 402 stores the update information in database 404, then cloud environment operating system 402 may automatically publish associated update information to each of the instances 408-a through 408-e, via each instance's respective update queue 412-a through 412-e. In some embodiments, some or all of the metadata sent in the original update message from updating instance may be distributed to each instance, while in some embodiments only substantive update information (e.g., key/value pairs) may be distributed to each instance, while metadata may be maintained only at a central store or database associated with the cloud environment operating system.

At step 508, the plurality of instances each stores the update information locally. In some embodiments, in response to receiving the update information, each instance may automatically write the update information to a respective associated local storage medium. In some embodiments, the update may be written to a cache, which may have expiration, eviction, and/or purging policies. In some embodiments, the update may be stored in a memory that has no expiration, eviction, or purging policies, such that the update may be considered to be durably stored. In some embodiments, writing or storing the update information may comprise storing substantive update information such as one or more as key/value pairs; in some embodiments, as writing or storing the update information may comprise storing metadata, such as the metadata discussed above.

### Read Operations in a Distributed Key/Value Store System

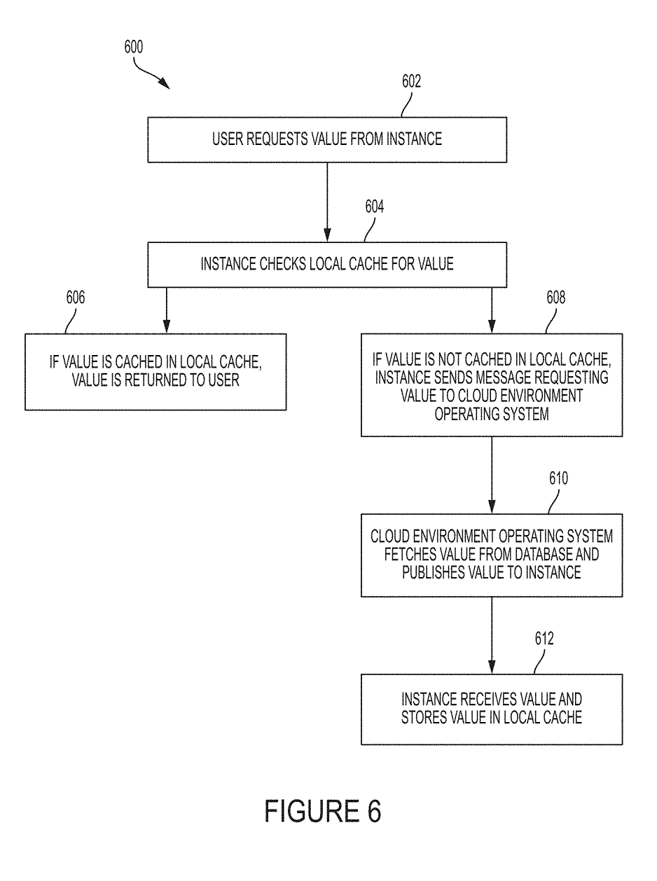

FIG. 6 is a flowchart showing method 600, which is an exemplary method for fetching a requested value at an instance of a system including a distributed key/value store, in accordance with some embodiments. In some embodiments, method 600 may be performed by system 400.

At step 602, a user requests value from instance. In some embodiments, the instance may be instance 408-a in FIG. 4. For example, a user of a laptop hosting an instance might request a key/value pair via the local instance.

At step 604, the instance checks a local cache for the requested value. For example, the local cache may be a memory on the laptop hosting the instance through which the user made the request, and the instance may search the local memory to determine whether the requested key/value pair is stored in the local memory.

At step 606, if the value is cached in the local cache, the value is returned to the user. In some embodiments, there may be a high probability that the requested value is stored in the local cache, because the distributed key/value store system may distribute updates effectively and efficiently soon after they are made.

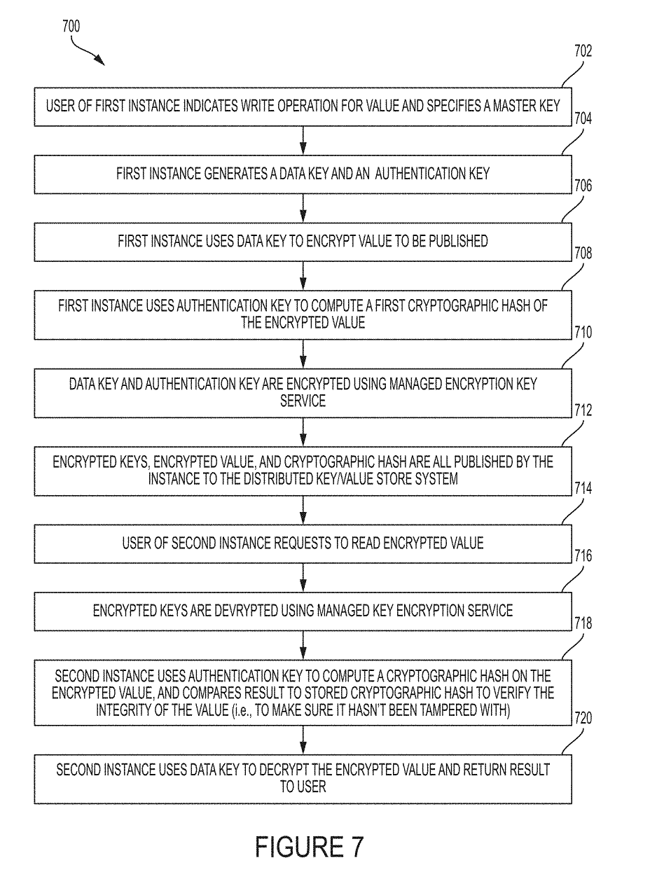

In some embodiments, the system may be configured such that no “off-box” calls are made when requesting/reading data that is found in a local memory or cache. In some embodiments, however, if the locally stored value is encrypted, then the item stored in cache may be stored along with a wrapped data encryption key, which the binary may send to a key management service to be decrypted. When the decrypted data encryption key is returned to the local instance from the key management service, then it may be used to decrypt the value and return the value to the user. This is discussed below in greater detail with reference to FIG. 7.

At step 608, if the value is not cached in the local cache, the instance sends a message requesting the value to a cloud environment operating system. In some embodiments, the message may be sent to the cloud environment operating system through a message queue of the cloud environment operating system. In some embodiments, the cloud environment operating system may be cloud environment operating system 402 of FIG. 4, and the message queue through which the message is sent may be queue 406. In some embodiments, the message sent may contain substantive request data identifying the value (e.g., the key/value pair) requested, and in some embodiments the message may contain metadata regarding the requesting user, requesting instance, time of the request, or other information. In some embodiments, the message may specify whether or not the read should be consistent.

In some embodiments, the steps of process 600 including and following step 608 may be performed if a user requests a refreshed or consistent read of a value. That is, in some embodiments, even if the requested value is stored in a local cache, the user may specifically request that the database be queried for the value.

At step 610, the cloud environment operating system fetches the value from a database and publishes the value to the instance. In some embodiments, the database may be database 404, and the requested value (e.g., key/value pair) may be stored in a log in the database. In some embodiments, the value may be published to the requesting instance by sending a message from the cloud environment operating system to the requesting instance through a message queue of the requesting instance. In some embodiments, the message queue through which the message is sent may be queue 412-a corresponding to instance 408-a. In some embodiments, the message sent may contain substantive data returning the requested value (e.g., the key/value pair), and in some embodiments the message may contain metadata regarding the requesting user, requesting instance, time of the request, time of the response message, location of the stored value in the database/log, or other information. In some embodiments, the message may be sent directly to the message queue of the requesting instance, rather than being broadcast to all instances associated with the system, since it may be assumed that most instances already have a locally cached record of the requested value, such as one that was distributed to them in accordance with method 500 described above with reference to FIG. 5

At step 612, the instance receives the value and stores the value in local cache. For example, instance 408-a may write the received value (in addition to any received metadata) to local storage such as cache 410-a. In some embodiments, by writing the value to local storage, future requests at the same instance for the same value may be served more quickly and more efficiently by reading the value from local storage instead of requiring that the value be fetched from a remote database.

Systems implementing methods 500 and 600 as described above with reference to FIGS. 4-6 may effectively broadcast an item of configuration or data from one node of a system, such that the item of configuration or other data is then cached by other nodes. Such systems may be cost-effective and efficient for read-heavy workloads, such as a workload in which a single node publishes database connection parameters to a fleet of web servers. In such a situation, a node may publish the database connection parameters once, and then they are read many times by web servers. In some embodiments, extensive instance-side caching may make read operations cheap, both in terms of performance and in terms of infrastructure costs. In some embodiments, most performance cost may be associated with write operations, and may therefore be associated with central databases associated with cloud environment operating systems, such as database 404 in FIG. 4, where write operations may be more expensive than read operations. In some embodiments, systems implementing methods 500 and 600 as described above with reference to FIGS. 4-6 may function effectively under write-heavy workloads, but may function most efficiently and inexpensively under read-heavy workloads because of extensive caching.

### Alternate Read/Write Operations in a Distributed Key/Value Store System

In some embodiments, alternate read and write operations may be performed in a distributed key/value store system using asynchronous messaging systems. Alternate read and write operations may share some or all of the characteristics and steps of the read and write operations explained above with reference to FIGS. 5 and 6. In some embodiments, alternate read and write operations may be executed by a system sharing some or all of the properties of the distributed key/value store system shown in FIG. 4.

In some embodiments, it may be preferable for instances in a distributed system to perform read and write operations to a database without the use of a central cloud environment operating system that acts directly on the database. Instead, in some embodiments, each instance may be capable of directly acting on the database to read its log and to write to its log. Furthermore, in some embodiments, each instance may be capable of directly publishing updates to each other instance after writing to the log in the database. In some embodiments, this arrangement may be thought of as similar to the arrangement discussed above with reference to FIGS. 4-6, with the difference that the computing/processing power that acts upon the database (e.g., database 404 in FIG. 4) is replicated and maintained redundantly on each individual instance (e.g., instances 408-a through 408-e) rather than on any central cloud environment operating system. Put another way, software may be additionally installed on each instance that allows each instance to carry out the same functionalities discussed above as being performed by cloud environment operating system 402.

In some embodiments, a distributed key/value store system not making use of a central cloud environment operating system to read from and write to the database may be referred to as a “headless” system. In write operations in headless systems, an instance may write directly to the database by communicating with it directly, rather than through a messaging queue and a centralized cloud environment operating system. After writing a new value to the database, the writing instance may then broadcast the new value to other instances in the same or similar way as discussed above with reference to FIG. 5, by publishing update information to the plurality of instances by sending a message through a notification system (e.g., to a specific broadcast topic) and through each of the instance's messaging queues. In read operations in headless systems, an instance may first check its local cache, and then (e.g., in the absence of the requested value in its local cache) may read directly from the database, rather than sending a message to a centralized cloud environment operating system requesting that the database be read.

In some embodiments, headless distributed key/value store systems may improve the speed of read and write operations. Particularly in systems in which read and write operations are often performed by instances located in or near the cloud environment operating system itself, performance may be improved by allowing instances to act directly on the database associated with the cloud environment operating system, rather than requiring all instances (even those within the cloud environment operating system) to send messages out to the Internet and then act on the database by communicating through the messaging queue of the cloud environment operating system. In some embodiments, headless systems may reduce read and write legacy times by 300 milliseconds or more per request.

In some embodiments, non-headless distributed key/value store systems (e.g., those in which the database may only be acted on by instances through the SQS queue of the cloud environment operating system) may be preferable to headless systems if security concerns dictate that every instance should not be able to act directly on the database. In some embodiments, instances may require certain permissions in cloud systems to be able to read and write directly to a database in a headless system; however, in a non-headless system, the only permission that may be required for each instance is the ability to send messages to the SQS queue of the cloud environment operating system and the permission to read messages from the instance's own SQS queue that is subscribed to the appropriate broadcast topic for the distributed key/value store system.

### Exemplary Commands in Some Embodiments of a Distributed Key/Value Store System

As explained above, a distributed key/value store system may, in some embodiments, leverage a binary installed on each of a plurality of instances of a cloud-based system. In some embodiments, each of the instances may be configured to receive certain commands and to responsively execute certain operations using the distributed key/value store system.

In some embodiments, the binary may operate as a long-running process to receive commands from a user or from other software, to receive updates from a cloud environment operating system, and to send commands to the cloud environment operating system. In some embodiments, the binary may be configured to run as a service, or may be configured to start upon command via a user's command-line instructions or via an instruction from another process.

While running, the binary can be used to perform operations on the key/value store, such as a log stored on a database associated with a cloud environment operating system (e.g., database 404 of FIG. 4).

In some embodiments, the binary may enable a put command that a user may call to write a key/value pair to the log in the database, thereby setting a certain key to a certain value. For example, in some embodiments the command “vars” may be used to call different functions of the binary, and a put command may be executed with the string “$ vars put”. Thus, for example, to set the key Hello to the value World, a put command may be run:
$ vars put Hello World
World
   In this example, the value returned (“World”) following the put command reflects the value that was stored in the database. In some embodiments, that value may also be stored in a local cache associated with the local instance, and/or in a plurality of caches associated with a plurality of other instances.

In some embodiments, the binary may enable a list command that a user may call to see what keys are in the store/log/database. In some embodiments, a list command may be executed with the string “$ vars list”. Thus, a list command may be run:
$ vars list
Hello konnichiwa hola
   In this example, the string returned shows that the database contains three keys, “Hello”, “konnichiwa”, and “hola”.

In some embodiments, the binary may enable a get command that a user may call to see what the value for a key is. In some embodiments, a get command may be executed with the string “$ vars get”. Thus, a get command may be run:
$ vars get hola
mundo
   In this example, the string returned shows that the value stored in the database for the key “hola” is “mundo”. In some embodiments, the process for retrieving a value for a key may share some or all attributes with process 600 as explained above with reference to FIG. 6.

In some embodiments, other commands may be enabled by the binary, such as delete commands and commands for getting groups of keys. Other options such as encrypted values, expiring keys, and different output serializations may also be implemented in some embodiments by the binary. Different syntax may be used to execute one or more of the commands and/or options discussed above, and the examples herein are merely for the purpose of illustration.

### API for a Distributed Key/Value Store System

In some embodiments, a binary for interacting with a distributed key/value store system, as discussed herein, may provide a RESTful API that may be used to interact with the system programmatically. In some embodiments, the command line of the distributed key/value store system may use the API. In some embodiments, the binary may bind only to the local interface, which means it may not accept external connections on a listener port, such as port 4444.

In some embodiments, the API may enable a user to execute HTTP requests to execute one or more of the commands or options discussed above, or to implement any other functionality of the binary.

In one example using the API, to store a key/value pair, a user may send an HTTP POST request to http://localhost:4444/[key] with a url-encoded post body containing the attribute value set to the value desired. For example, the following may set “Hello” to “World”:
$ curl http://localhost:4444/Hello” -d value=World
World
   In this example, the value returned (“World”) following the command reflects the value that was stored in the database. In some embodiments, that value may also be stored in a local cache associated with the local instance, and/or in a plurality of caches associated with a plurality of other instances.

In another example, to fetch a value, a user may send an HTTP GET request to http://localhost:4444/[key]. For example, the following may get the value from the “Hello” key:
$ curl http://localhost:4444/Hello
World
   In this example, the string returned shows that the value stored in the database for the key “hello” is “World”.

In another example, to list keys stored in the system, a user may send an HTTP OPTIONS request. For example:
$ curl http://localhost:4444/-XOPTIONS
Hello
   In this example, the string returned shows that the database contains one key, “Hello”.

In some embodiments, other commands and options may be enabled by the API, and different syntax may be used to execute one or more of the commands and/or options discussed above. The examples herein are merely for the purpose of illustration.

### Publishing Sensitive Configuration

In some embodiments, configuration information that needs to be shared may be sensitive information. For example, database passwords, API tokens, and cryptographic keys may be required for many modern applications, but users may be concerned about the security of this information. In some embodiments of the distributed key/value store system disclosed herein, an encrypted value feature may allow for the secure publication of sensitive configuration items by using envelope encryption.

FIG. 7 is a flowchart showing method 700, which is an exemplary method for securely publishing sensitive data using a system including a distributed key/value store and for reading the securely published data, in accordance with some embodiments. In some embodiments, method 700 may be performed by system 400.

At step 702, in some embodiments, a user of a first instance indicates a write operation for a value and specifies a master key. In some embodiments, the input may indicate a “put” operation and specifying the master key may be manually entered by a user, while in some embodiments the input may be automatically generated by another system or process with access to an instance of a distributed key/value store system. In one example, the input may be entered by a user of instance 408-a in FIG. 4.

In some embodiments, the master key specified is a key for a managed encryption key service, such as AMAZON KEY MANAGEMENT SERVICE (KMS), MICROSOFT KEY VAULT, or other services. In some embodiments, managed encryption key services may be web services that can be used to generate master keys, which are encryption keys, and to then perform operations with those master keys like encryption and decryption. In some embodiments, the master keys that generated by managed encryption key services may never leave the service. Though not shown in FIG. 4, a managed encryption key service may be communicatively coupled by network connections to any or all instances of a distributed key/value store system. Data may be sent to the service to be encrypted or decrypted, and the result may be sent back. In some embodiments, the service may be inexpensive, performant, and/or highly available, and/or may offer features for policy management and auditing. However, in some embodiments, a network round trip time and a limit on the size of the data that can be sent to a managed encryption key service may make the service non-optimal for bulk data encryption. Accordingly, in some embodiments, envelope encryption may be used to solve the problems caused by the limitations of managed encryption key services.

At step 704, in some embodiments, the first instance generates a data key and an authentication key. In some embodiments, the authentication key may be an HMAC key.

At step 706, in some embodiments, the data key is used by the first instance to encrypt a value that is to be published by the write operation. In some embodiments this value encryption may be performed using any robust encryption standard, including, for example, 256 bit Advanced Encryption Standard (AES) in counter-mode encryption (CTR mode), 256-bit AES in GCM mode, or other robust encryption standards.

At step 708, in some embodiments, the first instance uses authentication key to compute a first cryptographic hash of the encrypted value. Thus, in some embodiments, the output (e.g., encrypted data) generated by the data key and the value in step 706 are then further subjected to the authentication key in order to generate a first cryptographic hash. In some embodiments, ciphertext generated in step 706 is subject to an HMA key in order to generate an HMAC of the value ciphertext.

At step 710, in some embodiments, the data key and authentication key are encrypted using the managed encryption key service with the specified master key. In some embodiments, this encryption process includes the first instance sending the data key and the authentication key to the managed encryption key service, where the data key and encryption key are encrypted by the specified master key. In some embodiments, the specified master key may be indicated by a message sent from the first instance. In some embodiments, communication with the managed encryption key service may include HTTP communication, and may include an asynchronous handshake between the managed encryption key service and the instance with which it is communicating.

In some embodiments, to use the functionality of a managed encryption key service, a master key must be set up with the managed encryption key service in advance. This may be done, in some embodiments, through either a web interface or an API of a managed encryption key service. In some embodiments, managed encryption key services may support fine-grained access control, which may enable restricting use of a certain master key to specific servers or instances, such as specific web sections.

In some embodiments, encrypting the data key with the master key may be called key wrapping, and the result of the keys wrapping may be referred to as wrapped keys. In some embodiments, the wrapped keys may then be sent back from the managed encryption key service to the first instance. It should be noted that in some embodiments this step may be performed before, after, or at the same time as the steps discussed with reference to blocks 706 and 708.

At step 712, in some embodiments, the encrypted keys, encrypted value, and first cryptographic hash are all published by the first instance to the distributed key/value store system. Thus, in some embodiments, the “wrapped” data and HMAC keys, along with the encrypted value and its HMAC, may all be published from the first instance to the cloud environment operating system (or otherwise published to the distributed key/value store system). In some embodiments, the publication message including the information above may from that point forward be treated by the distributed key/value store system in the same or similar manner as an unencrypted or non-sensitive message to be published. In some embodiments, the publication process may be carried out in accordance with method 500 discussed above with reference to FIG. 5. For example, the publication message including the information above may be written to a database associated with a cloud environment operating system (e.g., database 404 in FIG. 4), and may be distributed out to other instances in the distributed key/value store system (e.g., instances 410-b through 410-e).

At step 714, in some embodiments, a user of a second instance requests to read the encrypted value that was created and broadcast as explained above with reference to steps 700-712. In some embodiments, the request may be indicated by a “get” operation, and may be manually entered by a user or may be automatically generated by another system or process with access to an instance of the distributed key/value store system. In one example, the input may be entered by a user of instance 408-b in FIG. 4.

At step 716, in some embodiments, the encrypted keys are decrypted using the managed encryption key service. In some embodiments, the second instance may send the encrypted keys to the managed encryption key service to be decrypted. Thus, the wrapped keys may be sent to the managed encryption key service, and the managed encryption key service may use the specified master key to decrypt the wrapped keys. Once decrypted, the un-encrypted data key and un-encrypted authentication key may be sent back to the second instance. In some embodiments, the managed encryption key service may know that the second instance is authorized due to a signed API request using an out-of-band mechanism that provides instances with credentials required to interface with the managed encryption key service.

At step 718, in some embodiments, the second instance uses the authentication key to compute a second cryptographic hash on the encrypted value, and compares the result to the stored first cryptographic hash to verify the integrity of the value. In some embodiments, the second instance may have a copy of the same authentication key stored in local memory that the first instance had stored in its local memory and that the first instance used to create the first cryptographic hash of the encrypted value. In some embodiments, the second instance may use the decrypted authentication key that it obtained from the distributed key/value store system.

If the second cryptographic hash calculated by the second instance is the same as the first cryptographic hash stored by the second instance after being calculated by the first instance, then the second instance may determine that encrypted value has not been tampered with or compromised, and may accordingly determine that the value is verified. In the event that the second cryptographic hash does not match the first cryptographic hash, then the second instance may determine that the value has been compromised and may not be authentic.

At step 720, in some embodiments, the second instance uses the data key to decrypt the encrypted value and return the un-encrypted value to the user of the second instance. In some embodiments, the second instance may only undertake step 720 if step 718 verifies the authenticity of the value by determining that the first and second cryptographic hashes match. In some embodiments, the second instance may have the same data key stored in local memory that the first instance had stored in its local memory and that the first instance used to create the encrypted value. In some embodiments, once the unencrypted value is calculated, it may be presented to the user of the second instance without being durably stored in the second instance, which may increase data security for sensitive information.

In one specific example using a KMS master key called “prod”, a write function with encryption in accordance with method 700 as explained above may be executed:
$ vars put dbpassword supersecret -e prod
2dItKnzNhaIqPSmNSejPsi/mqDdgc39C0Czt
   The long string that is shown as returned above may be the value that is actually persisted to the database of the cloud environment operating system and stored in the caches on various instances. To read an encrypted value from Vars, a normal “get” operation may be executed, and decryption may be carried out in accordance with method 700 as explained above:
$ vars get dbpassword
supersecret

By implementing the process above for publishing and reading sensitive information in a distributed key/value store system, in some embodiments, even though a value may be broadly published, it may be encrypted until a read or “get” operation occurs (e.g., steps 714-720). In some embodiments, the decryption may occur locally, the plaintext may not be cached, and the decryption may require access to the master key of the managed encryption key service. Thus, in some embodiments, even if a cache is copied from an instance or information is read from a table or log in the database associated with the cloud environment operating system, the value may remain protected if the unauthorized party does not also have access to the master key. In some embodiments, managed encryption key services may support fine-grained access control, which may enable restricting use of a certain master key to specific servers or instances, such as specific web sections. Thus, even if a web section secret is published to a cache section, the cache section instances may be unable to decrypt and read the sensitive information.

### First Example Use—Distributed Configuration and Service Registries

In some exemplary uses of a distributed key/value store system as discussed herein, a robust configuration registration and sharing system may be created by using the distributed key/value store system as a service registry.

In tiered web applications, fulfilling user traffic requests may require interaction with a database defined in a database section. In order to connect to the database, a web server may need several pieces of configuration, such as the hostname or IP address for the database, the port on which the database is listening, a username and password with which to authenticate the communication, the default database name, etc. One solution to ensuring the software on the web server can get that configuration information is to hard code the values into the web server image. However, that solution may make configuration changes difficult; for example, a new database endpoint or a new database password might require rolling a new image and replacing an entire fleet.

In some embodiments, a superior solution may be to use a service registry. A service registry may be generally understood as a key/value store at a known location where pieces of configuration can be stored and shared. Database endpoints, CDN URLs, software version numbers, and cluster member lists are all examples of runtime configuration that can be shared with infrastructure components via a service registry.

In some embodiments, a distributed key/value store system using asynchronous messaging systems, as disclosed herein, may be used as a service registry. In some embodiments, operators or infrastructure components themselves can publish values to the system that are usable by other components. In some embodiments, when a database instance is created, a cloud environment operating system may publish the database hostname to the distributed key/value store system for web servers to read and use. In some embodiments, an operator may publish database credentials (e.g., username and password) into the distributed key/value store system, and then web server software can read those credentials and use them to connect to the database.

### Publishing an IP Address

If a user desires to share an IP address (e.g., that of a cache instance) with various other instances (e.g., web section instances), then the user may publish the IP address value by using the distributed key/value store system disclosed herein to execute a “put” command and write the value to a database. In an exemplary embodiment, a user might execute an API command:
$ vars put cache_ip 172.16.2.56
172.16.2.56
   The IP address corresponding to the cache instance may then be distributed out to each instance in the distributed key/value store system. In some embodiments, each instance in the distributed key/value store system can be configured to fetch the IP address value at boot time and write it into a configuration file or environment variable; this may be done using a get command or an API function, as explained above.

### Automated Publishing on Boot

In some systems, certain servers may be cycled into and out of the system frequently, such as in systems where servers automatically regenerate. Furthermore, some systems may have multiple instances (e.g., multiple cache instances) whose IP addresses need to be shared with other instances (e.g., web section instances). Thus, in some systems, there may be a need for automated publishing of IP addresses for new instances, such that a human operator is not required to repeatedly manually enter a “put” command to write the value to a distributed key/value store system.

In some embodiments, a system may be configured to automatically provision, maintain, and replace cache instances by using a cloud operating system and images (e.g., AMAZON MACHINE IMAGES (AMIs)) included in a library of images associated with the cloud operating system. In such systems, in order to ensure that each cache instance's IP address enters the distributed key/value store system, instructions may be invoked that will read the current IP address and publish it to the distributed key/value store system. Thus, whenever a cache instance is booted, it may publish its IP address to the distributed key/value store system. Exemplary script may be as follows:
#!/bin/bash
IPADDR=$(ip addr show eth0|grep inet|awk ‘{print $2}’|cut -d/-f 1|head -1)
vars put cache_ip $IPADDR

### Watching Keys and Automating Reconfiguration

In some systems, certain components may fail and be re-instantiated, or may be intentionally periodically regenerated. For example, a cache instance in a cloud system may be periodically regenerated. Accordingly, there may be a need for other instances (e.g., web section instances) to know that the IP address of another instance (e.g., the regenerated cache instance) has changed.

In some embodiments, this problem may be addressed by configuring instances to poll the distributed key/value store system. In some instance, the system may be polled periodically, such as on a predetermined interval. For example, instances may be configured such that they execute a “get” command to read a cache IP address every 60 seconds.

However, in some embodiments, picking a non-optimal polling interval may lead to unpredictable failure modes, many schedulers may be too coarse to keep up with values that change several times per minute, and automation bookkeeping needed to update configuration on a change may be non-trivial. Accordingly, in some embodiments, the binary associated with the distributed key/value store system disclosed herein may in some embodiments have a feature enabling the system to watch one or more keys and to perform some action whenever a watched key is changed. In some embodiments, this feature may be enabled by default, while in some embodiments users may manually enable the feature.

In some embodiments, users may configure watching functionality by writing to a configuration file for the watch function. For example, a user might write to the configuration file:
foo touch/tmp/foo
   In this example, the string above may cause the system to watch the key “foo”, such that whenever it changes, the system will run the command “touch/tmp/foo”, which may update the access and modification times on the file “/etc/foo”.

In some embodiments, a watch functionality may be used to cause several things to happen automatically whenever a cache server boots:
1. The server may publish its IP address to the distributed key/value store system;
2. The new IP address will be replicated/distributed to all instances running the binary for the distributed key/value store system;
3. Each instance will execute a watch function when it receives the update; and
4. The watch function will call the script to update the cache IP address and reload the configuration.

Exemplary script for enabling the functionality laid out in the four steps above may be as follows:

\#!/bin/bash
CURRENTCACHE=$(vars get $WATCHEDKEY)
echo $CURRENTCACHE > /opt/refuge/cache_ip.conf
/etc/init.d/refuge reload

And that script may be set to run whenever a cache IP key is updated by using a watch functionality of the distributed key/value store system, as follows:
CACHE_IP bash /opt/refuge/setcache.sh

In some embodiments, the automated process laid out in the four steps above may enable a cloud-based system to function such that, whenever a new cache instance is instantiated, within seconds, every server in the system may be using the new cache instance. This may be achieved using the watch function as laid out above without any active monitoring or intervention by human operators.

### Second Example Use—Using a Distributed Key/Value Store System as a Lock Service

In some embodiments, it is desirable for only one instance in a cloud system to perform a task, even though multiple instances may be capable of performing the task. For example, certain tasks may be computationally expensive tasks or time-intensive tasks that should only be performed by one instance, even though maintaining multiple instances that are capable of performing the task may be desirable in case of failure of one or more of the instances. As one specific example, a cloud system may contain two or more jobs host instances that may be tasked with performing a database pruning operation (in which older data is removed from the database) intermittently, such as once per hour. However, despite having multiple instances capable of performing the pruning operation, such that one may crash and the other(s) may carry on, a user may desire that only one instance performs the pruning task each hour, so as not to be computationally wasteful or redundant. Various other tasks, such as database schema migration, backups, and metric rollup, may also be optimized when one instance performs the task.

Accordingly, there is a need in distributed systems for techniques that ensure that only one instance of multiple instances will perform a task. In some embodiments, this may be achieved by using a distributed key/value store system, as described herein, as a lock service.

In traditional programming environments, a lock service may cause tasks to execute such that, from among multiple actors (or threads or services), only one actor (or thread or service) may perform a task at once. Before attempting to perform the task, all actors may first try to acquire a lock. Only once a lock is successfully acquired may the actor perform the task, and while the lock is actively held by one actor, all other actors may receive an error or block message when trying to acquire the lock. The lock may be released when the task is complete.

In some embodiments, read and write operations executed by a distributed key/value store system as disclosed herein may provide the functionalities of a lock, and may thereby serve as a lock service. In some embodiments, a distributed key/value store system may be configured such that it will not operate stale data. This may be achieved, in some embodiments, by including, in a write message sent from an instance to a cloud environment operating system, data reflecting the most recently cached value that the write operation seeks to overwrite.

For example, suppose a key is set to the value “foo” in a central database, and a first instance tries to rewrite the value to “bar” just seconds before a second instance trues to set the value to “baz”. When both instances send their update messages to the cloud environment operating system, the messages may each include the value that they wish to write as well as the most recently cached value of which the instance is aware (e.g., the value they wish to overwrite). That is, both instances indicate in their respective message that they intend to overwrite the old value “foo”. In some embodiments, when it receives a write message from an instance, the cloud environment operating system may only carry out the write operation if the message correctly indicates the current value to be overwritten. Thus, if the message from the first instance arrives first, then “foo” may be overwritten to “bar”. Then, if the message from the second instance arrives thereafter, the message will incorrectly indicate that the value to be overwritten is still “foo”, and the actual value “bar” will not be overwritten to “baz”. Instead, an error message may be returned to the second instance.

This mechanism may be harnessed to perform locking, in accordance with some methods.

First, in some embodiments, a key may be selected and associated with a certain task. Taking the example discussed above of the database pruning task, a key “database-prune” may be declared, and whenever an instance attempts the database pruning task, the instance may do so in accordance with the following steps.

In some embodiments, the instance reads a value from the task key. For example, an instance may read the value of the key “database-prune”.

In some embodiments, if a value is returned, then this may signify that another instance is performing the task (e.g., pruning the database). In accordance with the determination that another instance is currently performing the task, the instance may refrain from performing the task.

In some embodiments, however, if no value is returned, then this may indicate that no other host is performing the task (e.g., pruning the database). In accordance with the determination that no other instance is pruning the database, the instance may write its own instance ID (or any other instance-specific identifier) to the key “database-prune”.

In some embodiments, if the cloud environment operating system then returns the value that the instance just wrote, then that may indicate that it is still the case that no other instance is performing the task (e.g., pruning the database), and the instance may responsively perform the task.

In some embodiments, if the cloud environment operating system returns an error, then this may indicate that another instance is performing the task (e.g., pruning the database), and the instance may responsively refrain from the pruning operation.

In some embodiments, the process laid out above may be further improved by replacing the read and write operations with an atomic operation termed a compare and swap (CAS) operation. In some embodiments, a CAS operation may be operative to update a value if and only if the current value is a certain value. For example, a CAS operation may be used to update a value to “bar” if and only if the current value is “foo”. As one example, a CAS operation may be used to update the key “example” to the value “bar” only if the current value is “foo”:
$ vars cas example foo bar
bar
   If another instance thereafter tried to update the key “example” from “foo” to “baz”, then an error would be returned because the current value is no longer “foo”:
$ vars cas example foo baz
LOCK_ERROR: The current value of example is not foo

In some embodiments, this operation may be understood to impose similar semantics in the local binary and local cache as those that govern the cloud environment operating system and database, where a value may only be overwritten if the current value is correctly indicated. By replacing the separate read and write operations with a CAS operation, erroneous results attributable to an instance being updated between separate read and write operations may be avoided.

In one example of using a CAS operation in conjunction with the locking service method laid out above, a distributed key/value store system may be used to perform a pruning job (where the script for the pruning job has path “/opt/refuge/scripts/db_prune.sh”) in accordance with the following:
$ vars cas database_prune ““$INSTANCE_ID &&
/opt/refuge/scripts/db_prune.sh

In some embodiments, a distributed key/value store system acting as a lock service may be further improved by implementing expiring keys. In some embodiments, expiring keys may be used to create locks that also expire. This may address the issue of instances that may crash while holding a lock, which may cause a system to be permanently locked to the crashed instance (which will never release the lock). In some embodiments, when it seeks to acquire a lock, an instance may specify a “time to live” for the value that it assigns the locking key. This time to live might be, for example, five minutes. If the instance completes the task in less than the time to live, then the instance may release the lock. If the instance requires longer than the time to live to complete the task, then the instance may refresh its lock by re-putting the item. Finally, if the instance crashes while holding the lock, then the value will naturally expire after the time to live, and another instance checking whether the task is locked will then see no value, and will be able to claim the lock for itself.

What is claimed is:

1. A method for updating a value in a distributed key/value store system, comprising:
at a network communication component:
receiving, from an instance of the distributed key value store system, a message indicating a key and corresponding value; and
in response to receiving the message:
storing the key and corresponding value in a database; and
publishing an update indicating the key and corresponding value to a plurality of instances of the key/value store system.

2. The method of claim 1, wherein the network communication component is a virtual computing component executing first instructions enabling it to interact with the plurality of instances in the distributed key/value store system

3. The method of claim 1, wherein each of the plurality of instances is a virtual computing component executing second instructions enabling it to interact with the network communication component.

4. The method of claim 1, wherein receiving the message comprises retrieving the message from a queue of an asynchronous messaging system.

5. The method of claim 1, wherein publishing the update comprises sending the update through a notification system to which each of the plurality of instances is subscribed.

6. The method of claim 5, wherein:
each of the plurality of instances is associated with a respective queue of an asynchronous messaging system; and
each of the plurality of instances is subscribed to the notification system to retrieve, via its respective queue, messages from the notification system.

7. The method of claim 1, wherein:
each of the plurality of instances is associated with a respective local cache; and
each of the plurality of instances is configured to, in response to receiving the key and corresponding value, store the corresponding value in its respective local cache.

8. A non-transitory computer-readable storage medium storing instructions for updating a value in a distributed key/value store system, the instructions comprising instructions for:
at a network communication component:
receiving, from an instance of the distributed key value store system, a message indicating a key and corresponding value; and
in response to receiving the message:
storing the key and corresponding value in a database; and
publishing an update indicating the key and corresponding value to a plurality of instances of the key/value store system.

9. A system for updating a value in a distributed key/value store system, the system comprising one or more instances of the distributed key/value store system and memory storing instructions that, when executed, cause the system to:
at a network communication component:
receive, from an instance of the distributed key value store system, a message indicating a key and corresponding value; and
in response to receiving the message:
store the key and corresponding value in a database; and
publish an update indicating the key and corresponding value to a plurality of instances of the key/value store system.

10. A method for retrieving a value in a distributed key/value store system, comprising:
at an instance of the distributed key/value store system:
receiving a request to retrieve a value; and
in response to receiving the request to retrieve the value:
determining whether the value is stored in a local cache associated with the instance of the distributed key/value store system;
in accordance with the determination that the value is stored in the local cache, retrieving the value from the local cache; and
in accordance with the determination that the value is not stored in the local cache:
sending a message to a network communication component of the distributed key/value store system, the message indicating a key corresponding to the requested value; and
receiving, from the network communication component, a response including the requested value.

11. The method of claim 10, wherein the network communication component is a virtual computing component executing first instructions enabling it to interact with a plurality of instances in the distributed key/value store system, wherein the instance is one of the plurality of instances.

12. The method of claim 10, wherein each of the plurality of instances is a virtual computing component executing second instructions enabling it to interact with the network communication component.

13. The method of claim 10, wherein sending the message to the network communication component comprises sending the message to a first queue of an asynchronous messaging system, the first queue being associated with the network communication component.

14. The method of claim 10, wherein receiving the response from the network communication component comprises retrieving the message from a second queue of an asynchronous messaging system, the second queue being associated with the instance.

15. The method of claim 10, further comprising, after receiving the response including the requested value, storing the value in the local cache.

16. The method of claim 10, wherein the network communication component is configured to retrieve, based on the key, the requested value from a database.

17. A non-transitory computer-readable storage medium storing instructions for retrieving a value in a distributed key/value store system, the instructions comprising instructions for:
at an instance of the distributed key/value store system:
receiving a request to retrieve a value; and
in response to receiving the request to retrieve the value:
determining whether the value is stored in a local cache associated with the instance of the distributed key/value store system;
in accordance with the determination that the value is stored in the local cache, retrieving the value from the local cache; and
in accordance with the determination that the value is not stored in the local cache:
sending a message to a network communication component of the distributed key/value store system, the message indicating a key corresponding to the requested value; and
receiving, from the network communication component, a response including the requested value.

18. A system for retrieving a value in a distributed key/value store system, the system comprising one or more instances of the distributed key/value store system and memory storing instructions that, when executed, cause the system to:
at an instance of the distributed key/value store system:
receive a request to retrieve a value; and
in response to receiving the request to retrieve the value:
determine whether the value is stored in a local cache associated with the instance of the distributed key/value store system;
in accordance with the determination that the value is stored in the local cache, retrieve the value from the local cache; and
in accordance with the determination that the value is not stored in the local cache:
send a message to a network communication component of the distributed key/value store system, the message indicating a key corresponding to the requested value; and
receive, from the network communication component, a response including the requested value.

19. A method for securely publishing values via a distributed key/value store system, comprising:
encrypting a data key and an authentication key;
at a first instance of the distributed key/value store system:
using the data key to encrypt a value;
using the authentication key to compute a first hash of the encrypted value; and
publishing the encrypted value, the first hash, and the encrypted keys, via an asynchronous messaging service, to a plurality of instances of the distributed key/value store system.

20. The method of claim 19, wherein encrypting the data key and the authentication key comprises sending the data key and the authentication key to a managed encryption key service for encryption.

21. The method of claim 19, wherein publishing the encrypted value, the first hash, and the encrypted keys comprises sending the encrypted value, the first hash, and the encrypted keys through a notification system to which each of the plurality of instances is subscribed.

22. The method of claim 19, further comprising:
at a second instance of the distributed key/value store system:
receiving the encrypted value, the first hash, and the encrypted keys via the asynchronous messaging service;
obtaining the data key in decrypted form;
using the data key to decrypt the encrypted value to obtain the value in unencrypted form.

23. The method of claim 22, further comprising:
obtaining the authentication key in unencrypted form;
using the authentication key to compute a second hash of the encrypted value;
comparing the first hash and the second hash to authenticate the integrity of the received encrypted value.

24. The method of claim 23, wherein obtaining the data key and authentication key in decrypted form comprises sending the encrypted keys to a managed encryption key service for decryption.

25. A non-transitory computer-readable storage medium storing instructions for securely publishing values via a distributed key/value store system, the instructions comprising instructions for:
encrypting a data key and an authentication key;
at a first instance of the distributed key/value store system:
using the data key to encrypt a value;
using the authentication key to compute a first hash of the encrypted value; and
publishing the encrypted value, the first hash, and the encrypted keys, via an asynchronous messaging service, to a plurality of instances of the distributed key/value store system.

26. A system for securely publishing values via a distributed key/value store system, the system comprising one or more instances of the distributed key/value store system and memory storing instructions that, when executed, cause the system to:
encrypt a data key and an authentication key;
at a first instance of the distributed key/value store system:
use the data key to encrypt a value;
use the authentication key to compute a first hash of the encrypted value; and
publish the encrypted value, the first hash, and the encrypted keys, via an asynchronous messaging service, to a plurality of instances of the distributed key/value store system.
